(19) United States
(12) Patent Application Publication
(10) Pub. No.: US 2012/0299796 A1
(43) Pub. Date: Nov. 29, 2012

(54) Module for Carrying Antennas of a Telecommunication System and Antenna Mast Arrangement

(75) Inventor: Jan Angseryd, Taby (SE)

(73) Assignee: TELEFONAKTIEBOLAGET LM ERICSSON (PUBL), Stockholm (SE)

(21) Appl. No.: 13/576,090

(22) PCT Filed: Feb. 5, 2010
(86) PCT No.: PCT/SE2010/050141

§ 371 Date: Jul. 30, 2012

(51) Int. Cl. H01Q 9/34

(52) U.S. Cl. 343/875

(57) ABSTRACT

A module (2) for carrying antennas (32, 62) of a telecommunication system is provided. The module comprises a substantially vertically extending central arrangement for attaching antennas (32, 62) thereto and an outer portion radially at a distance from the central arrangement. The module (2) has an upper end and a lower end. The central arrangement comprises, a first pipe section (4) at the lower end and a second pipe (60) or pole (6) extending from the first pipe section (4) towards the upper end. The first pipe section (4) further comprises a climbing arrangement arranged inside the first pipe section (4) and is provided with a passage opening (10) for personnel to access the second pipe (60) or pole (6). The second pipe (60) or pole (6) has a smaller outer diameter than the first pipe section (4). An antenna mast arrangement is also provided.

### TECHNICAL FIELD

The present invention relates to a module for carrying antennas of a telecommunication system according to the precharacterizing portion of claim 1 as well as an antenna mast arrangement comprising an antenna mast body and such a module.

### BACKGROUND

An antenna mast for a wireless communication system is provided with one or more antennas at its upper end. The antennas may be of one type only or of different types and may be adapted to perform different functions in the wireless communication system. Examples of such functions may be communication between a mobile communication device and a radio base station arranged in or at an antenna mast, and communication between a radio base station in or at a relevant antenna mast and a radio base station at a different location than the relevant antenna mast.

Antenna masts may be constructed using different techniques. Examples are: steel lattice masts, masts comprising one or more steel tubes and masts comprising one or more reinforced concrete tubes. Accordingly, the expression “antenna mast” is intended to encompass antenna masts with an open structure, such a lattice, as well as masts with a closed structure such as a tubular mast, e.g. in the form of a tower.

The antennas at the top end of an antenna mast may be arranged so as to be fully visible or enclosed in a so-called radome. A radome may conceal the antennas from public view and accordingly prevent theft and damage of the antennas. A radome may also protect the antennas against influences of weather to a certain extent. A radome may be made from a glass fibre reinforced material.

Antennas of wireless communication systems may also be arranged on other buildings than dedicated masts. They may for instance be arranged on roof tops of office buildings or residential blocks. Also when arranged on a roof top, the antennas may be attached to a structure, e.g. a steel lattice construction.

DE 20 2005 010 140 U1 discloses an antenna construction wherein the antennas at the top of the construction are arranged inside an outer shell made from a material permeable to radio waves in the range of the antennas. According to one embodiment the antennas are attached to a pipe arranged centrally inside the outer shell.

DE 9407220 U1 and FR 2850418 disclose telecommunication antenna masts provided with several platforms for carrying antennas at their upper ends.

### SUMMARY

An object of the present invention is to provide an arrangement for carrying antennas of a telecommunication system wherein access is provided to the antennas.

According to an aspect of the invention, the object is achieved by a module for carrying antennas of a telecommunication system, comprising a substantially vertically extending central arrangement for attaching antennas thereto and an outer portion radially at a distance from the central arrangement. The module has an upper end and a lower end. Further, the central arrangement comprises a first pipe section at the lower end and a second pipe or pole extending from the first pipe section towards the upper end. The first pipe section comprises a climbing arrangement arranged inside the first pipe section and is provided with a passage opening for personnel to access the second pipe or pole. The second pipe or pole has a smaller outer diameter than the first pipe section.

Since the central arrangement of the module comprises a first pipe section of a greater diameter than the second pipe or pole, service personnel may exit the first pipe section to access antennas, for instance antennas attached to the second pipe or pole. As a result, the above mentioned object is achieved. It is to be understood that the climbing arrangement is arranged for service personnel to climb an inside of the first pipe section.

The module as such may be attached at its lower end to an antenna mast arrangement, for instance an antenna mast arrangement comprising a hollow body made from reinforced concrete. The module may be attached at its lower to a different kind of structure, e.g. to the roof of a building. Accordingly, the module at its lower end may be provided with an attachment arrangement adapted for attaching the module to a mast arrangement or a roof of a building or similar. The outer portion radially at a distance from the central arrangement may be a radome covering extending around the module, or it may be a platform, frame portions or walls extending outwardly from the central arrangement. Such platforms or frame portions may extend radially to a distance beyond antennas to be attached to the module.

According to example embodiments the first pipe section may at its outer perimeter have an attachment arrangement for attaching antennas. Attaching of antennas to the first pipe section may thus be facilitated since the antennas may be attached directly to the attachment arrangement. When an antenna is to be attached to the first pipe section it is accordingly not necessary to firstly provide some kind of anchoring means to the first pipe section. The antenna may be attached to the attachment arrangement. Such attachment arrangement may be a number of loops, one or more rails, a number of bolts or similar devices. The passage opening is arranged above the attachment arrangement and accordingly above at least parts of antennas attached to the first pipe section.

According to example embodiments a wall section of the first pipe section may be provided with at least one access opening for accessing antennas arranged on an outer side of the first pipe section. An antenna attached to the first pipe section may be reached, and e.g. serviced, from an inside of the first pipe section through the access opening without personnel having to exit the first pipe section. An antenna attached to the second pipe or pole may be accessed through the passage opening as mentioned above. The at least one access opening may be provided with a door.

According to example embodiments the passage opening may be provided with a covering arrangement. By means of the covering arrangement, e.g. in the form of a door, a canvas or similar, the first pipe section may be closed and protected from weather forces.

According to example embodiments at least one substantially vertical first wall may extend radially outwards from the first pipe section. By means of such vertical walls a space outside of the first pipe section may be divided into sectors.

According to example embodiments the second pipe or pole may extend at least partially through the first pipe section. The second pipe or pole may thus be attached to the first pipe section inside the first pipe section. The second pipe or pole may be attached to an inside of the first pipe section by means of substantially horizontal bars. At least some of such horizontal bars may be utilized for climbing an inside of the first pipe section.

According to example embodiments a platform may be arranged substantially at a level of the passage opening. The platform may be utilized by service personnel when servicing antennas attached to the second pipe section or pole.

According to example embodiments a roof may be arranged at the said upper end of the module. The roof may at least partially protect the rest of the module from precipitation.

According to example embodiments a frame may be arranged between the platform and the roof. The frame may be utilized for attaching and/or stabilizing the roof to/on the module.

According to example embodiments at least one substantially vertical second wall may be attached to the frame. The second wall may divide a space surrounding the second pipe or pole into sectors.

According to example embodiments the first pipe section may be adapted for attaching antennas of a first type to the first pipe section and the second pipe or pole may be adapted for attaching antennas of a second type to the second pipe or pole.

According to example aspects an antenna mast arrangement may comprise an antenna mast body and a module for carrying antennas of a telecommunication system according any example embodiment discussed above arranged at an upper end of the antenna mast body.

According to example embodiments the module for carrying antennas of a telecommunication system comprises antennas of a first type attached to the first pipe section and antennas of a second type attached to the second pipe or pole.

According to example embodiments the antenna mast arrangement may be a tubular telecommunication tower and the antenna mast body may be made from reinforced concrete.

Further features of, and advantages with, the present invention will become apparent when studying the appended claims and the following description. Those skilled in the art will realize that different features of the present invention may be combined to create embodiments other than those described in the following, without departing from the scope of the present invention, as defined by the appended claims.

### BRIEF DESCRIPTION OF THE DRAWINGS

The various aspects of the invention, including its particular features and advantages, will be readily understood from the following detailed description and the accompanying drawings, in which:

FIG. 1 illustrates a module for carrying antennas of a telecommunication system according to example embodiments,

FIG. 2 illustrates a lower end of a module for carrying antennas of a telecommunication system according to example embodiments, arranged at a top end of an antenna mast body of an antenna mast arrangement, and

FIG. 3 illustrates a cross section of an antenna mast arrangement according to example embodiments, at an upper end of which a module for carrying antennas of a telecommunication system according to example embodiments is arranged.

### DETAILED DESCRIPTION

The present invention will now be described more fully with reference to the accompanying drawings, in which example embodiments are shown. However, this invention should not be construed as limited to the embodiments set forth herein. Disclosed features of example embodiments may be combined as readily understood by one of ordinary skill in the art to which this invention belongs. Like numbers refer to like elements throughout.

Well-known functions or constructions may not be described in detail for brevity and/or clarity.

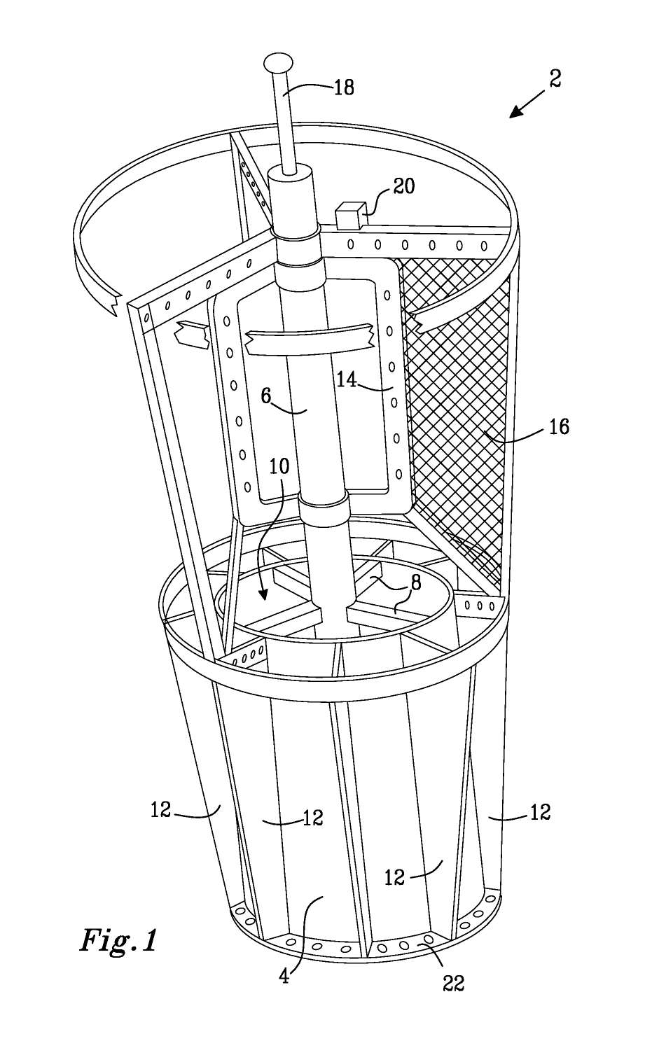

FIG. 1 illustrates a module 2 for carrying antennas of a telecommunication system according to example embodiments. The module 2 comprises a first pipe section 4 at a lower end of the module and a pole 6 at an upper end of the module 2. The pole 6 extends partially through the first pipe section 4 and is attached inside the first pipe section 4 by means of horizontal bars 8. An outer side of the first pipe section 4 is arranged for attachment of antennas of the telecommunication system. Similarly, the pole 6 is arranged for attaching antennas of the telecommunication system thereto. The first pipe section 4 is internally climbable and is provided with a passage opening 10 at its upper end for personnel to exit from the first pipe section 4 to access at least antennas attached to the pole 6.

Vertical first walls 12 extend radially from the first pipe section 4. The wall sections 12 partition the outer side of the first pipe section 4 into sectors, in each of which one or more antennas may be arranged. The wall sections 12 may also define at least part of an outer contour of the module 2.

A frame 14 is arranged at an upper end of the module 2. The frame 4 is attached at its radially inner ends to the pole 6 and at its lower end to the first pipe section 6. The latter attachment may be achieved indirectly via the first walls 12. The frame 14 supports second wall sections 16, which in this example have a mesh structure as shown by the one illustrated wall section 16. At its upper end the frame 14 supports a not-shown roof.

The module 2 at its upper end is provided with a lightning conductor, in the form of a metal rod 18. The lightning conductor is connected to e.g. a grounding plate. Also at the upper end of the module there is arranged a warning light 20, which indicates a position of the module 2 when it is arranged in an elevated position at the top of an antenna mast body or on the roof top of a building. At its lower end the module 2 comprises an attachment arrangement for attaching the module 2 to an antenna body or a roof top of building. The attachment arrangement is illustrated in the form of a flange 22 provided with through holes, which flange 22 is adapted to be bolted to a relevant structure. Alternative attachment arrangements may of course be used, such as separate lugs or clamps. The attachment arrangement may be arranged at an inner side of the first pipe section 4.

Purely as an example of size and proportions, the module 2 may have an outer diameter of 2 m at its lowest end, a diameter of 2.7 m at its roof and a total height of 5 m. The first pipe section 4 may have a diameter of 1.5 m. Of course these dimensions may vary within a wide range, e.g. 1-3 m diameter at the lowest end and 1.5-4 m at the roof end of the module 2, the height of the module 2 3-7 m and the diameter of the first pipe section 4 0.7-2 m.

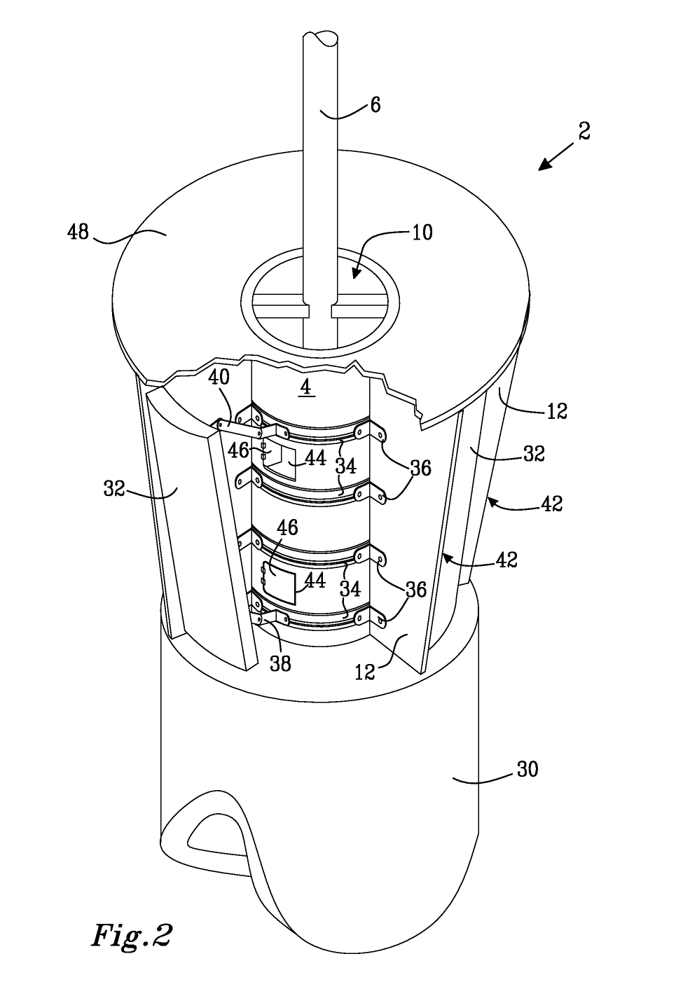

FIG. 2 illustrates a lower end of a module 2 for carrying antennas of a telecommunication system according to example embodiments, arranged at a top end of an antenna mast body 30 of an antenna mast arrangement. A first pipe section 4 of the module 2 is provided on its outer side with an attachment assembly adapted for attaching one or more antennas 32 to the first pipe section 4. The attachment assembly may also be adapted for attaching one or more first walls 12 to the first pipe section 4.

The attachment assembly may comprise one or more rails 34 extending at least partially around the first pipe section 4. The antennas 32 and/or the first walls 12 may engage directly with the one or more rails 34. Alternatively, or in combination with direct engagement, the attachment assembly may comprise brackets 36, 38, 40 for connecting the one or more antennas 32 and/or one or more of the first walls 12 to the first pipe section 4 and the module 2. The one or more rails 34 may for instance have a C-shaped, T-shaped or L-shaped cross section. The brackets 36, 38, 40 may be of various types, including a fixed bracket 36 which permits movement of an attached part in a circumferential direction when the fixed bracket 36 is arranged in/on the rail 34 before the bracket 36 has been tightened to the rail 34; a hinged bracket 38 which permits pivoting of an attached part in addition to the above mentioned movement in the circumferential direction; and a linked bracket 40 which permits adapting a distance between an attached part and the rail 34 in addition to the above mentioned movement in the circumferential direction.

Since the one or more rails 34 extend at least partially around the first pipe section 4, the one or more antennas 32 and/or the one or more first walls 12 may be displaced in a circumferential direction around the first pipe section 4. Accordingly, the one or more antennas 32 may be arranged and distributed in a circumferential direction of the first pipe section 4 as required by local conditions at a site of e.g. an antenna mast arrangement. Also, the one or more first walls 12 may be arranged circumferentially as desired to provide sectors for one or more of the antennas 32 on an outside of the first pipe section 4. Also, replacing of the first walls 12 with differently shaped first walls 12 is easily achieved. Accordingly, an outer edge 42 of the first walls 12 may have a particular shape to lend the module 2 a characteristic outer contour. In this case the first walls 12 extend a greater distance from the first pipe section 4 at their upper ends than at their lower ends and the outer edges 42 of the first walls 12 are straight such that the outer contour of the module 2 will be that of an inverted truncated cone.

By means of the different types of brackets 36, 38, 40 the one or more antennas 32 and/or the one or more first walls 12 may be attached in suitable positions on the one or more rails 34. For instance, an antenna 32 may be tilted at a desired angle by using a linked bracket 40 at an upper portion of the antenna 32 and a hinged bracket 38 at a lower portion of the antenna 32.

The first pipe section 4 is provided with one or more access openings 44 in its circumferential wall. Each access opening 44 may be provided with a hatch or door 46. Through an access opening 44 personnel may reach an antenna 32, at least one rail 34 and at least one of the brackets 36, 38, 40 from an inside of the first pipe section 4. Accordingly, personnel may perform service on the antennas 32 attached at an outside of the first pipe section 4 without having to exit the first pipe section 4. The access openings 44 may also prove to be useful when installing antennas 32. Through an access opening 44 personnel may easily position a relevant antenna 32 by looking out though the access opening 44 and aiming the antenna 32 in a desired direction. Aiming is easily done because surrounding landmarks can be used as they are visible through the access opening 44. Positioning of the antenna 4 may be done both in a circumferential direction of the first pipe section 4 and by tilting one or both ends of the antenna 32 when one or more of the brackets 36, 38, 40 are loose. After positioning the antenna, the brackets 36, 38, 40 are tightened.

A circular platform 48 is arranged at an upper end of the first pipe section 4. The platform 48 is reached via a passage opening 10 at the upper end of the first pipe section 4. Personnel may stand on the platform 48 to reach inter alia not-shown antennas mounted on a pole 6 of the module 2.

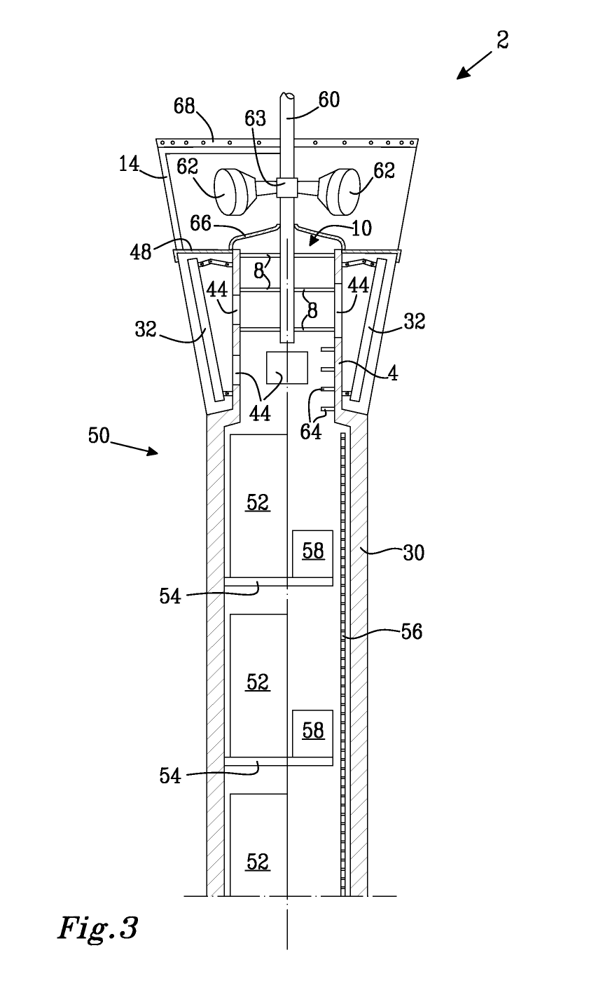

FIG. 3 illustrates a cross section of an antenna mast arrangement 50 according to example embodiments, at an upper end of which a module 2 for carrying antennas of a telecommunication system according to example embodiments is arranged. The module 2 is attached to an antenna mast body 30 of the antenna mast arrangement 50. The antenna mast body 30 is made from reinforced concrete. Inside the antenna mast body 30 there are arranged three radio base stations 52 on separate floor sections 54. Service personnel may reach the radio base stations 52 by climbing a ladder 56. Doors 58 in the floor sections 54 provide access to each floor section 54 and a relevant radio base station 52.

The module 2 comprises a first pipe section 4 and a second pipe 60, to both of which antennas of the telecommunication system are attached. The antennas may be of two types. For instance antennas 32 of a first type may be attached to the first pipe section 4 and antennas 62 of a second type may be attached to the second pipe section 60. The second pipe 60 extends inside the first pipe section 4 and is attached thereto by means of horizontal bars 8.

Antennas 32 of the first type again, may be attached to the first pipe section 4 by means of an attachment assembly comprising rails and brackets as described above. Antennas 62 of the second type may be attached to the second pipe 60 by means of one or more clamps 63. The one or more clamps 63 may be loosened and fastened by means of bolts such that the antennas 62 of the second type may be positioned in desired directions. The antennas 32 of the first type may be arranged for communication between a base station 52 and a wireless communication device such as mobile telephone or lap top computer. The antennas 62 of the second type may be arranged for communication between a base station 52 and a base station placed in a different location than the present antenna mast arrangement 50.

The first pipe section 4 is internally climbable by means of ladder steps 64 and, optionally, at least some of the horizontal bars 8. At its upper end the first pipe section 4 is provided with a passage opening 10, through which personnel may exit onto a platform 48 arranged circumferentially around the upper end of the first pipe section 4. The passage opening 10 may be covered by a covering arrangement, for instance in the form of a canvas 66. The canvas 66 may be provided with a zipper or buttons such that at least part of the passage opening 10 may be uncovered by removing or folding of the canvas 66. Again, wall sections of the first pipe section 4 are provided with access openings 44 for accessing the antennas 32 from an inside of the first pipe section 4.

The module 2 is provided at its upper end with a roof 68. The roof 68 may be attached to the second pipe 60 and/or a schematically illustrated frame 14 extending to the platform 48. The roof 68 at least partially protects the module 2 from precipitation and defines an outer contour of the module 2.

Example embodiments may be combined as understood by a person skilled in the art. Although the invention has been described with reference to example embodiments, many different alterations, modifications and the like will become apparent for those skilled in the art. The first pipe section may for instance be of a different shape than circular. It may instead be a polygonal pipe. Antennas of different types may be attached to the first pipe and/or the second pipe or pole.

Therefore, it is to be understood that the foregoing is illustrative of various example embodiments and the invention is not to be limited to the specific embodiments disclosed and that modifications to the disclosed embodiments, combinations of features of disclosed embodiments as well as other embodiments are intended to be included within the scope of the appended claims.

As used herein, the term “comprising” or “comprises” is open-ended, and includes one or more stated features, elements, steps, components or functions but does not preclude the presence or addition of one or more other features, elements, steps, components, functions or groups thereof.

As used herein, the term “and/or” includes any and all combinations of one or more of the associated listed items.

As used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e.”, which derives from the Latin phrase “id est”, may be used to specify a particular item from a more general recitation.

The terminology used herein is for the purpose of describing particular embodiments only and is not intended to be limiting of the invention. As used herein, the singular forms “a”, an and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present.

1-14. (canceled)

15. A module for carrying antennas of a telecommunication system, said module having an upper end and a lower end and comprising:
a substantially vertically extending central arrangement for attaching antennas thereto, said central arrangement comprising a first pipe section at said lower end and a second pipe or pole extending from said first pipe section towards said upper end, said second pipe or pole having a smaller outer diameter than said first pipe section, wherein said first pipe section comprises a climbing arrangement arranged inside said first pipe section, and wherein said first pipe section at its outer perimeter has an attachment arrangement for attaching antennas;
an antenna attached to the attachment arrangement of said first pipe section; and
an outer portion radially at a distance from said central arrangement;
wherein said first pipe section is provided with a passage opening for personnel to access said second pipe or pole and antennas attached to said second pipe or pole, and wherein a wall section of said first pipe section is provided with at least one access opening for accessing antennas arranged on an outer side of said first pipe section, such that the antenna attached to the first pipe section is reachable from an inside of the first pipe section through the access opening without personnel having to exit the first pipe section.

16. The module of claim 15, wherein said at least one access opening is provided with a door.

17. The module of claim 15, wherein said passage opening is provided with a covering arrangement.

18. The module of claim 15, wherein said central arrangement comprises at least one substantially vertical first wall extending radially outwards from said first pipe section to said outer portion.

19. The module of claim 19, wherein said second pipe or pole extends at least partially through said first pipe section.

20. The module of claim 19, wherein said second pipe or pole is attached to an inside of said first pipe section by means of substantially horizontal bars.

21. The module of claim 15, wherein a platform is arranged substantially at a level of said passage opening.

22. The module of claim 15, wherein a roof is arranged at said upper end.

23. The module of claim 22, further comprising a platform arranged substantially at a level of said passage opening and a frame is arranged between said platform and said roof.

24. The module of claim 23, wherein at least one substantially vertical second wall is attached to said frame.

25. The module of claim 15, wherein said first pipe section is adapted for attaching antennas of a first type to said first pipe section and said second pipe or pole is adapted for attaching antennas of a second type to said second pipe or pole.

26. An antenna mast arrangement, comprising
an antenna mast body, and
a module for carrying antennas of a telecommunication system, said module being arranged at an upper end of said antenna mast body, having an upper end and a lower end, and comprising:
a substantially vertically extending central arrangement for attaching antennas thereto, said central arrangement comprising a first pipe section at said lower end and a second pipe or pole extending from said first pipe section towards said upper end, said second pipe or pole having a smaller outer diameter than said first pipe section, wherein said first pipe section comprises a climbing arrangement arranged inside said first pipe section, and wherein said first pipe section at its outer perimeter has an attachment arrangement for attaching antennas;
an antenna attached to the attachment arrangement of said first pipe section; and
an outer portion radially at a distance from said central arrangement;
wherein said first pipe section is provided with a passage opening for personnel to access said second pipe or pole and antennas attached to said second pipe or pole, and wherein a wall section of said first pipe section is provided with at least one access opening for accessing antennas arranged on an outer side of said first pipe section, such that the antenna attached to the first pipe section is reachable from an inside of the first pipe section through the access opening without personnel having to exit the first pipe section.

27. The antenna mast arrangement of claim 26, wherein said module for carrying antennas of a telecommunication system comprises antennas of a first type attached to said first pipe section and antennas of a second type attached to said second pipe or pole.

28. The antenna mast arrangement according to claim 26, wherein said antenna mast arrangement is a tubular telecommunication tower and said antenna mast body is made from reinforced concrete.
